(19) United States
(12) Patent Application Publication
(10) Pub. No.: US 2013/0024544 A1
(43) Pub. Date: Jan. 24, 2013

(54) Electronic Book Capable of Making Content of Magazine Into Community

(71) Applicant: Kentarou Oshita, Chiyoda-ku (JP)

(72) Inventor: Kentarou Oshita, Chiyoda-ku (JP)

(73) Assignee: BIJUTSU SHUPPAN NETWORKS CO., LTD., Tokyo (JP)

(21) Appl. No.: 13/582,454

(22) PCT Filed: Apr. 15, 2011
(86) PCT No.: PCT/JP2011/002247

§ 371 Date: Sep. 3, 2012

(30) Foreign Application Priority Data
Apr. 15, 2010 (JP) 2010-094041

(51) Int. Cl. G06F 15/16

(52) U.S. Cl. 709/217

(57) ABSTRACT

Disclosed is an electronic book system capable of providing a community for pages thereof and capable of imparting a sense of integration to a plurality of users. The disclosed electronic book system is fundamentally based on the finding that by allowing content included in a page of a book to be specified and by allowing a comment related to the content to be input, a community can be provided for pages of an electronic book and a sense of integration can be imparted to a plurality of users. The disclosed electronic book system includes a terminal capable of displaying the electronic book and an electronic book server connected via a communication line to the terminal.

### TECHNICAL FIELD

The present invention relates to an electronic book system. More specifically, the present invention relates to an electronic book system capable of making a publication into a community and bringing togetherness to multiple users.

### BACKGROUND ART

Japanese Patent Application Laid-Open (JP-A) No. 2007-156783 discloses an electronic book system. In this electronic book system, an electronic book is downloaded to a user's terminal, and the electronic book can be displayed on the user's terminal.

### CITATION LIST

### Patent Literature

Patent Literature 1: JP-A No 2007-156783

### SUMMARY OF INVENTION

### Technical Problem

With the electronic book system disclosed in JP-A No. 2007-156783, an electronic book can be downloaded to a user's terminal. However, this system is basically made for the purpose of allowing the user to download the electronic book, and is not for the purpose of communication between users. As a result, this system is no more than simply allowing a user to view a book with an electronic medium.

Accordingly, it is an object of the present invention to provide an electronic book system capable of making a publication into a community and bringing togetherness to multiple users.

### Solution to Problem

The present invention is basically made on the basis of the following finding. A publication of an electronic book can be made into community by allowing a user to specify a content included in a page of a book and inputting a comment in association with the content, which can bring togetherness to a plurality of users.

A first aspect of the present invention relates to an electronic book system. This electronic book system 13 includes a terminal 11 capable of displaying an electronic book and an electronic book server 12 connected to the terminal 11 via a communication network.

The electronic book server 12 includes an electronic book storage part 21, a receiving part 22 of the electronic book server, a reading part 23, an information updating part 24, and a transmitting part 25 of the electronic book server. The electronic book storage part 21 stores a page (page) image of an electronic book, a content included in the electronic book, an allocated region of the content, and a comment associated with the content. The receiving part 22 of the electronic book server receives information transmitted from the terminal 11. The reading part 23 reads information about an electronic book stored in the electronic book storage part 21, on the basis of information received by the receiving part 22 of the electronic book server. The information updating part 24 updates the information stored in the electronic book storage part 21 on the basis of information received by the receiving part 22 of the electronic book server. The transmitting part 25 of the electronic book server transmits, to the terminal 11, information about the electronic book including one or more contents read by the reading part 23.

The terminal includes a receiving part 31 of the terminal, a display part 32, a content specifying part 33, an input part 34 of the terminal, and a transmitting part 35 of the terminal. The receiving part 31 of the terminal receives information about the electronic book transmitted from the electronic book server 12. Information about the electronic book includes information about one or more contents. The display part 32 displays information about the electronic book, on the basis of the information about the electronic book received by the receiving part 31 of the terminal. The content specifying part 33 specifies a particular content included in the electronic book including the one or more contents displayed on the display part 32, by selecting an allocated region of a content. The input part 34 of the terminal inputs an instruction and a comment about the content specified by the content specifying part 33. The transmitting part 35 of the terminal transmits, to the electronic book server 12, the instruction and the comment about the content which is input by the input part 34 of the terminal.

In the electronic book system according to the present invention, an allocated region of a content is a region including an image of the content displayed on the display part 32 of the terminal. In the present invention, there is an allocated region of a content on a page displayed on the terminal, and therefore, a user can specify a content using the region. This allows the user to freely input a comment about the content. Further, the comment, which is input by the user with the terminal, is transmitted to the electronic book server 12, and is stored in association with the content, and therefore, comments which are input by various users can be viewed in association with the content.

In a preferred aspect of an electronic book system according to the present invention, the electronic book server 12 further includes an icon storage part 41 for storing an icon displayed on the terminal 11 and a comment presence/absence determining part 42. The comment presence/absence determining part 42 is an element for determining presence/absence of a comment stored in association with a content included in the electronic book storage part 21. When the comment presence/absence determining part 42 determines that there is a comment associated with a content displayed on the terminal 11, the transmitting part 25 of the electronic book server transmits, to the terminal 11, information for displaying an icon in association with the comment,

As a result, the contents having a comment therefor are displayed with icons are displayed On the terminal.

In a preferred aspect of all electronic book system according to the present invention, the electronic book storage part 21 further stores an ID of a user who posted a comment, a posting time of the comment, and the number of times the comment has been browsed, which are stored in association with the comment. In addition, the electronic book server 12 includes an icon storage part 41 for storing multiple types of icons displayed on the terminal 11, a user information storage part 43 for storing information about a user including an ID of the user, and an icon deciding part 44 for determining an icon displayed on the terminal, using the ID of the user who posted the comment, the posting time of the comment, and the number of times the comment has been browsed. The transmitting part 25 of the electronic book server transmits, to the terminal 11, information for displaying the icon determined by the icon deciding part 44, in association with the comment.

Different icons can be displayed according to the ID of the user who posted the comment, the posting time of the comment, and the number of times the comment is viewed, and therefore, a user can select an appropriate comment.

In a preferred aspect of an electronic book system according to the present invention, the electronic book server 12 includes a page image retrieving part 51 for retrieving a page image of a book and a content region determining part 52 for obtaining region information of a content included in a page by sweeping a page image of the book retrieved by the page image retrieving part 51.

With the electronic book system according to this aspect, for example, regions of contents can be automatically found by just scanning a book made of a paper medium, and these can be made into allocated regions of the contents.

In a preferred aspect of an electronic book system according to the present invention, the terminal 11 further includes a camera 53 for capturing an image, and the transmitting part 35 of the terminal transmits image data of a certain page of a certain book taken with the camera 53 to the electronic book server 12. Then, the electronic book server 12 receives the image data of the page transmitted from the terminal 11, reads information about the received page from the electronic book storage part 21, and transmits the information to the terminal 11.

With the electronic book system according to this aspect, for example, a user can readily obtain a comment about a content included in a publication, when the user is concerned about other people's opinions while the user reads a magazine on paper.

In a preferred aspect of an electronic book system according to the present invention, the content includes an image of clothes, and the electronic book server 12 further includes a user information storage part 43 for storing information about a user including an avatar of the user and an ID of the user and a clothes image generating part 55 for generating an image in which an avatar wears clothes, using an avatar of a user and an image of clothes.

Unless a user considers how the user looks when the user actually puts on clothes and considers the clothes in view of a combination, preference in terms of a single item and actual usefulness are different. However, according to the above aspect, the user can find how the user looks when the user actually puts on the clothes, and in addition, the user can evaluate a combination with other clothes, accessories, and the like. For this reason, an electronic book system that attracts much attention from users can be provided.

In addition, the electronic book server 12 may include:

an electronic book storage part 21 storing page images of an electronic book, contents included in the electronic book, allocated regions of the content, and comments associated with the content;

an icon storage part 41 storing multiple icons displayed on the terminal 11 as well as icon numerical values respectively set for the icons;

a total numerical value storage part 56 storing a total numerical value of icon numerical values for each icon stored in the icon storage part 41, in association with a content stored in the electronic book storage part 21;

a receiving part 22 of the electronic book server receiving information transmitted from the terminal 11;

a reading part 23 reading information about an electronic book stored in the electronic book storage part 21 and information about an icon stored in the icon storage part 41, on the basis of information received by the receiving part 22 of the electronic book server;

an information updating part 24 updating the information stored in the electronic book storage part 21 and the total numerical value stored in the total numerical value storage part 56, on the basis of information received by the receiving part 22 of the electronic book server; and

a transmitting part 25 of the electronic book server transmitting, to the terminal 11, information about the electronic book including one or more contents read by the reading part 23 as well as information about multiple icons.

In this case, the terminal 11 may include:

a receiving part 31 of the terminal receiving information about multiple icons and information about the electronic book including one or more contents transmitted from the electronic book server 12;

a display part 32 displaying the information about the electronic book and multiple icons, on the basis of the information about the electronic book received by the receiving part 31 of the terminal;

a content specifying part 33 specifying a particular content included in the electronic book including one or more contents displayed on the display part 32, by selecting an allocated region of a content;

an input part 34 of the terminal inputting an instruction and a comment about the content specified by the content specifying part 33;

an icon selecting part 57 selecting an icon associated with the content specified by the content specifying part 33 from among multiple icons displayed on the display part 32; and

a transmitting part 35 of the terminal transmitting, to the electronic book server 12, the instruction and the comment about the content which are input with the input part 34 of the terminal and the icon selected with the icon selecting part 57.

In this case, an allocated region of a content is preferably a region including an image of a content displayed on the display part 32 of the terminal.

When the electronic book server 12 receives information about an icon from the terminal, the electronic book server 12 preferably causes the information updating part 24 to update the total numerical value of the icon numerical values stored in the total numerical value storage part 56, in association with the icon received from the terminal 12, and the electronic book server 12 preferably transmits, to the terminal 12 via the transmitting part 25 of the server, information for displaying the total numerical value of the icon updated by the information updating part 24.

Because of such configuration, the present invention allows a user to select an icon in association with a specified content from among multiple icons displayed on the display part 32 of the terminal 11. This icon represents, for example, feeling that the user has about the specified content. The user selects an icon representing feeling in association with a content as necessary. An icon numerical value is set for each icon. Every time the user selects an icon in association with a particular content, the icon numerical value is accumulated, added, and stored for each type of icon in association with the particular content. The total numerical value of the icon numerical values thus accumulated and added is displayed on the display part 32 of the user's terminal 11. Therefore, a certain user can visually understand what kind of feeling that the other users have about a particular content by seeing the total numerical value of the icon numerical values. In particular, in the present invention, an icon selected by a user can be associated with a particular content along with a user's comment, and therefore user's concern about the particular content can be represented more effectively.

In addition, the electronic book server 12 preferably further includes:

an image data storage part 58 storing threshold values of the total numerical values stored in the total numerical value storage part 56 as well as multiple pieces of image data; and

an image data transmitting part 59 transmitting, to the terminal 11, information for displaying the piece of image data, which is more than the threshold value, on the display part 32 of the terminal 11 when the total numerical value updated by the information updating part 24 is more than the threshold value stored in the image data storage part 58.

As described above, according to the present invention, the image data can be displayed on the display part 32 of the terminal 11, upon a determination that the total numerical value accumulated and added for each icon in association with the content stored in the total numerical value storage part 56 is more than a certain threshold value. Therefore, the user can visually understand, based on the image data, that the icon numerical value of the icon associated with the particular content (for example, a numerical value representing feeling) is more than a certain value. Therefore, in the present invention, images can be displayed to attract attention from users.

### Advantageous Effects of Invention

With the electronic book system according to the present invention, allocated regions are provided for contents, and a user can specify a content. A publication can be made into a community, and this brings togetherness to multiple users.

### BRIEF DESCRIPTION OF DRAWING

FIG. 1 is a block diagram for illustrating an electronic book system according to the present invention.

FIG. 2 is a figure illustrating an example of a certain page of a book.

FIG. 3 is a figure illustrating an example of a certain page image of an electronic book displayed on a terminal.

FIG. 4 is a figure illustrating an example of display of a mode in which a comment stored in association with each content can be viewed.

FIGS. 5(a) and 5(b) are figures illustrating how a content region determining part 52 performs processing, wherein FIG. 5(a) illustrates an image before sweeping, and FIG. 5(b) illustrates an example of a processed image after sweeping.

FIG. 6 is a block diagram illustrating an aspect of embodiment (computer) of the present invention.

FIG. 7 is a block diagram illustrating all embodiment (game machine) of present invention.

FIG. 8 is a block diagram illustrating an embodiment (cellular phone having computer graphic function) of the present invention.

FIG. 9 is a picture showing switching to a drawing illustrating an example in which a terminal displaying an electronic book displays a page image.

FIG. 10 is a picture showing switching to a drawing illustrating an example of a page image in which icons and comments are displayed.

FIG. 11 is a figure illustrating an example of an image displayed on a display part of a terminal of another embodiment of the present invention.

### DESCRIPTION OF EMBODIMENTS

Hereinafter, modes for carrying out the present invention will be explained with reference to drawings. The present invention is not limited to the modes explained below. The present invention also includes those obtained by modifying, as necessary, the modes explained below without deviating from the scope that is obvious to a person skilled in the art. In addition, the present invention can employ, as necessary, all the configurations and operations related to an electronic book system at the time of filing of the present application.

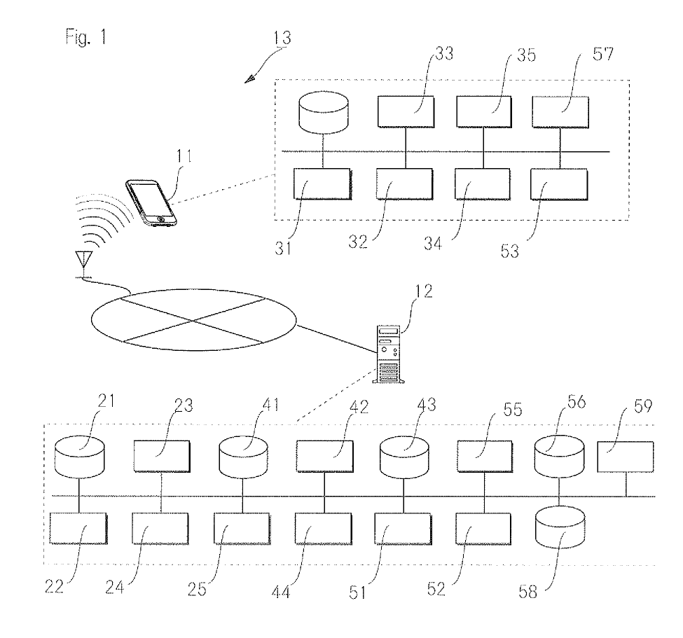

FIG. 1 is a block diagram for illustrating an electronic book system according to the present invention. As illustrated in FIG. 1, an electronic book system 13 of the present invention includes a terminal 11 capable of displaying an electronic book and an electronic book server 12 connected to the terminal 11 via a communication network. Therefore, the terminal 11 and the electronic book server 12 can exchange data.

An example of terminal 11 is a portable electronic book called an electronic book. The terminal 11 may be a portable computer, a cellular phone, a portable game machine, or a PDA. The electronic book server 12 includes a computer constituting a server. The server 12 includes an input and output part, a control part, a calculation part, and a storage part. Further, these elements are connected via a bus and the like, so that information can be exchanged. More specifically, when predetermined information is input with the input and output part, the control part reads a control program stored in a main memory of the storage part. Then, the control part reads data stored in the storage part as necessary in accordance with an instruction of the control program, and the calculation part performs predetermined calculation. Then, the calculation result is temporarily stored to the storage part, and is output from the input and output part. The terminal also has the same configuration as the above.

The electronic book server 12 as illustrated in FIG. 1 includes an electronic book storage part 21, a receiving part 22 of the electronic book server, a reading part 23, an information updating part 24, a transmitting part 25 of the electronic book server, an icon storage part 41, a comment presence/absence determining part 42, a user information storage part 43, an icon deciding part 44, a page image retrieving part 51, a content region determining part 52, and a clothes image generating part 55. The electronic book server 12 according to the present invention may have any configuration of the above configuration. In addition, the electronic book server 12 according to the present invention may have any element other than the above configuration.

The electronic book storage part 21 is an element for storing page images of an electronic book, contents included in the electronic book, allocated regions of the content, and comments associated with the content. A database in the server functions as the electronic book storage part 21. A preferred database is a relational database. A preferred database stores electronic books, pages, page images, contents included in the electronic book, an allocated region of each content on a page, and a comment associated with a content, which are stored in association with each other. The preferred electronic book storage part 21 further stores an ID of a user who posted a comment, a posting time of the comment, and the number of times the comment is viewed, which are stored in association with the comment.

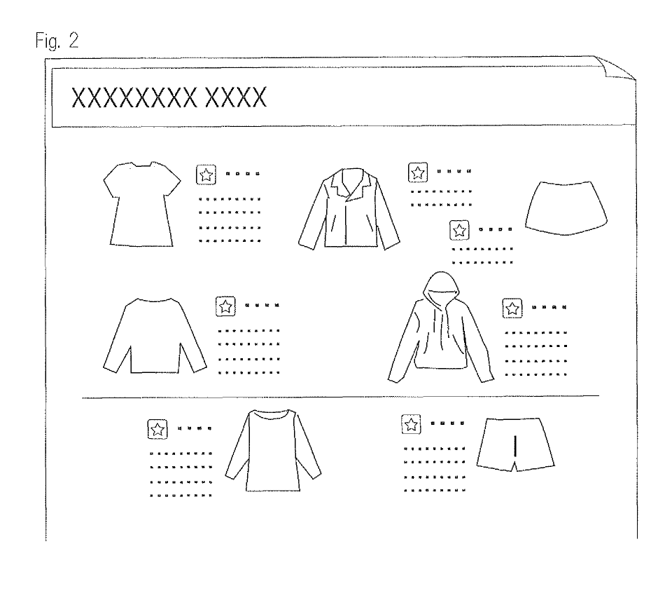

FIG. 2 illustrates an example of a certain page of a book. This page includes pictures of multiple clothes which are shown as contents. In the example of FIG. 2, an explanation about a suit of clothes is described as a text in association with a picture of the suit of clothes which is a content.

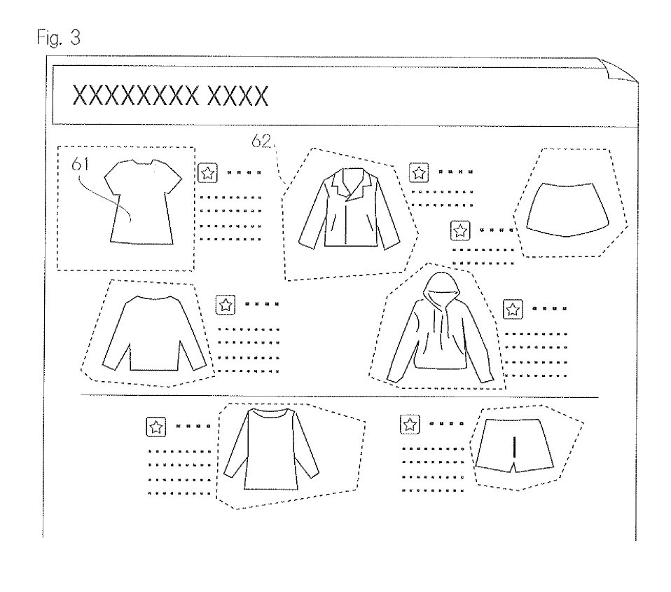

FIG. 3 illustrates an example of a certain page image of an electronic book displayed on a terminal. This example is based on the page as illustrated in FIG. 2. The page image may be an image obtained by scanning a paper medium. Alternatively, the page image may be electronically drawn from the scratch. In the present invention, the page image is preferably a one obtained by scanning a paper medium. As illustrated in FIG. 3, a picture (image) representing each product on this page exists as a content. In other words, this page includes multiple contents 61. As illustrated in FIG. 3, a content allocated region 62 is allocated to each content, although this is not displayed on the terminal in a normal state. As illustrated in FIG. 3, this allocated region 62 preferably does not overlap the allocated regions 62 of the other contents.

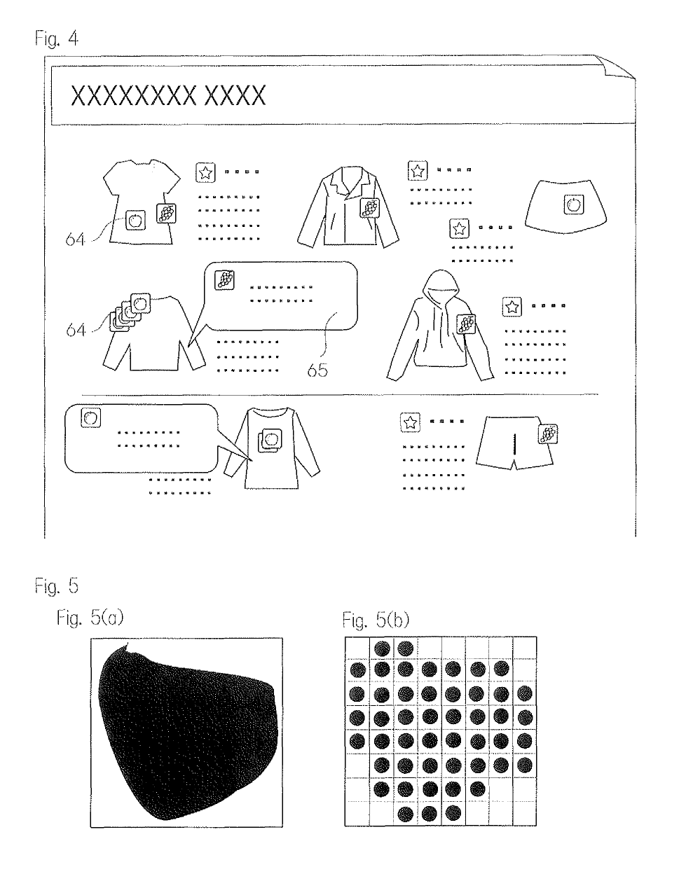

FIG. 4 illustrates an example of display of a mode in which a comment stored in association with each content can be viewed. In FIG. 4, for a content with which a comment is stored, an icon 64 is displayed on the image of the content. The type and the color of the icon 64 may be changed according to the comment and the like. Then, when a particular icon 64 is selected, a comment 65 stored in association with the icon is displayed. The example of the comment in association with the content is a tweet of Twitter (registered trademark).

The receiving part 22 of the electronic book server is an element for receiving information transmitted from the terminal 11. Usually, a server has a transmission/reception device. Therefore, a publicly known one can be used as necessary for the receiving part 22 of the electronic book server according to the present invention.

The reading part 23 is an element for reading information about an electronic book stored in the electronic book storage part 21 on the basis of information received by the receiving part 22 of the electronic book server. For example, the electronic book server 12 receives information indicating a selection of an icon 64 from the terminal 11. Then, the electronic book server 12 reads a comment 65 stored in association with the icon 64 from the electronic book storage part 21, and transmits the comment 65 to the terminal 11. Then, the display part of the terminal 11 displays the comment 65 in association with the icon 64.

The information updating part 24 is an element for updating information stored in the electronic book storage part 21 on the basis of information received by the receiving part 22 of the electronic book server. For example, it is assumed that a certain user displays a page of an electronic book on the terminal 11, specifies a certain content, and inputs a comment. Then, the terminal 11 transmits the specified content and the input comment to the electronic book server. Then, the information updating part 24 stores the received comment in association with the specified content. At this occasion, it is preferable to also store an ID of a content provider. Due to existence of the information updating part 24, comments from users are accumulated.

The transmitting part 25 of the electronic book server is an element for transmitting, to the terminal 11, information about an electronic book including one or more contents read by the reading part 23.

The icon storage part 41 is an element for storing an icon displayed on the terminal 11. The icon storage part 41 preferably stores multiple types of icons displayed on the terminal 11. Information about an image of an icon may be stored to the terminal 11, and the icon storage part 41 may store an ID of the icon stored in the terminal 11.

The comment presence/absence determining part 42 is an element for determining presence/absence of a comment stored in association with a content included in the electronic book storage part 21. When the comment presence/absence determining part 42 determines that there is a comment associated with a content displayed on the terminal 11, the transmitting part 25 of the electronic book server transmits, to the terminal 11, information for displaying an icon in association with the comment. Then, as illustrated in FIG. 4, the icon 64 is displayed on the image of the content 61.

The user information storage part 43 is an element for storing information about a user including an ID of the user. The user information storage part 43 preferably stores information about a user including an avatar of the user and an ID of the user. When the electronic book server is connected to the terminal 11, the electronic book server obtains the ID of the user associated with the terminal 11. Since the user information storage part 43 stores the ID of the user, calculation processing can be performed according to the ID of the user. When the electronic book server 12 receives a comment from the terminal 11, the comment is stored in association with the ID of the user, so that the type and color of the icon displayed in association with the comment can be changed. For example, when the ID of the user is a commercial ID (for example, an ID starting with 5), the picture of the icon may be changed to a picture of an abacus.

The icon deciding part 44 is an element for determining an icon displayed on the terminal, using the ID of the user who posted the comment, the posting time of the comment, and the number of times the comment is viewed.

The transmitting part 25 of the electronic book server transmits, to the terminal 11, information for displaying the icon determined by the icon deciding part 44, in association with the comment. Then, as illustrated in FIG. 4, the terminal 11 can display the comment 65 in association with the icon 64.

The page image retrieving part 51 is an element for retrieving a page image of a book. For example, the electronic book server 12 may be connected to a scanner or an image-capturing part.

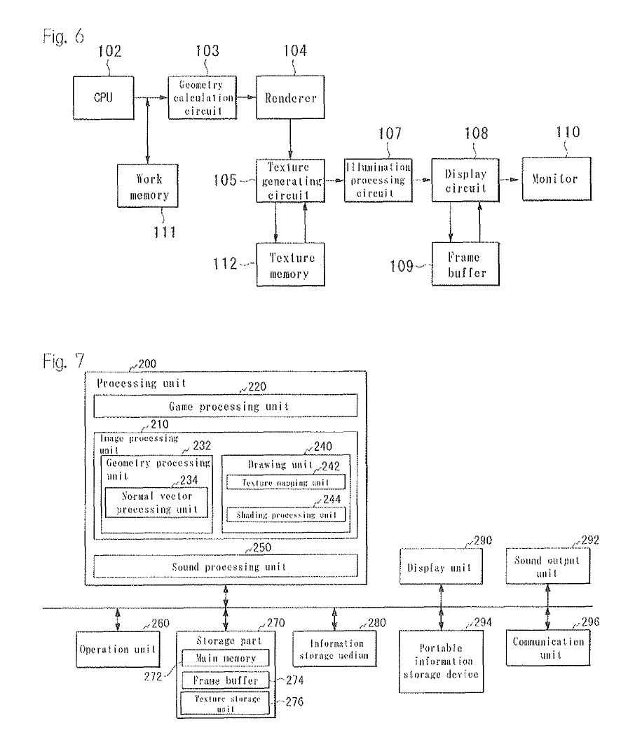

The content region determining part 52 is an element for obtaining region information of a content included in a page by sweeping a page image of a book retrieved by the page image retrieving part 51. FIGS. 5(a) and 5(b) are figures illustrating how the content region determining part 52 performs processing. FIG. 5(a) illustrates an image before sweeping. FIG. 5(b) illustrates an example of a processed image after sweeping.

The clothes image generating part 55 is an element for generating an image in which an avatar wears clothes, using an avatar of a user and an image of clothes.

The terminal as illustrated in FIG. 1 includes a receiving part 31 of the terminal, a display part 32, a content specifying part 33, an input part 34 of the terminal, a transmitting part 35 of the terminal, and a camera 53.

The receiving part 31 of the terminal is an element for receiving information about an electronic book including one or more contents transmitted from the electronic book server 12.

The display part 32 is an element for displaying information about an electronic book, on the basis of information about the electronic book received by the receiving part 31 of the terminal.

The content specifying part 33 is an element for specifying a particular content included in an electronic book including one or more contents displayed on the display part 32, by selecting an allocated region of the content. The terminal 11 has an input device such as an arrow key. For example, the display part includes an instruction icon. The instruction icon moves on the display part upon receiving input from an arrow key. The instruction icon is moved using the arrow key, and when the instruction icon is located at an allocated region of a certain content, and selection information is input, the content is specified.

The input part 34 of the terminal is an element for inputting an instruction and a comment about the content specified by the content specifying part 33. It should be noted that the display part 32 may be a touch panel, and the display part may be a part of the input part 34. In this case, the content can be easily specified by indicating the image of the displayed content.

The transmitting part 35 of the terminal is an element for transmitting, to the electronic book server 12, the instruction and the comment about the content which are input with the input part 34 of the terminal.

The camera 53 is an element for capturing an image. A camera or an image-capturing part provided in a portable terminal is already known. Therefore, a publicly known camera can also be employed as necessary in the present invention.

Subsequently, an example of operation of the electronic book according to the present invention will be explained.

Generation of Electronic Book Data

For example, the server administrator pushes a certain page of a book to the image-capturing part of the scanner. Then, the scanner is activated. Then, the image-capturing part of the scanner scans the page of the book to obtain a page image of the book. Then, the page image of the book obtained with the scanner is transmitted to the electronic book server, and the page image retrieving part 51 stores the received page image of the book to the electronic book storage part 21. At this occasion, the server administrator may input information about the page retrieved into the server, and the electronic book storage part 21 may store the input information. Examples of information about the retrieved page include a title, the number of page, and a genre of the book including the page.

For example, it is assumed that a portion as illustrated in FIG. 5(a) exists in the page image of the book retrieved by the page image retrieving part 51. In this case, the content region determining part 52 sweeps (scans) the image for each line (or each column). Then, for example, for each pixel, average color information is obtained. The book includes a background, a content image, and a text. The background portion is usually a color used for an end portion and the like, or white. In a portion where a text exists, there is usually a portion where a background can be seen. Therefore, when the image is swept, when as many pixels as a predetermined number of pixels or more continuously exist in a color different from the background color, this portion may be recognized as a region where a content image exist. Alternatively, a function of publicly-known OCR software may be used to recognize a text portion. In addition, the electronic book server 12 performs calculation for determining an allocated region of a content. For example, the electronic book server 12 has the location where the image of the content exists, and accordingly, the region where the image exists may be adopted as the allocated region of the content. Further, the electronic book server 12 has the location of the content and the location of the text. In some cases, depending on users, the image of the content cannot be correctly indicated. On the other hand, there may be a case where a link is attached to a text portion. Therefore, as illustrated in FIG. 3, the electronic book server 12 may perform calculation processing, for each content, such that a region including an image (or a picture) indicating the content but not including a text portion is adopted as a region allocated to the content. By doing so, while making use of the link attached to the letters, the content can be indicated.

User Views Electronic Book

The user of the terminal 11 captures an image of a certain page of a book using the camera 53. Then, the transmitting part 35 of the terminal transmits image data of the certain page of the certain book captured with the camera 53 to the electronic book server 12. Then, the electronic book server 12 receives the image data of the page transmitted from the terminal 11. The electronic book server 12 analyzes the received image data, and determines which page stored in the electronic book storage part 21 the page is. At this occasion, the content included in the received page may be recognized by doing the same processing as the generation of the electronic book data described above, and using information about the display region of the content and the type of the content, the page may be compared with pages stored in the electronic book storage part 21. At this occasion, the page may be compared using information about the positional relationship and the types of multiple contents. Then, the electronic book server 12 uses information about the matched page to read information about the received page from the electronic book storage part 21. This information about the page includes information for causing the terminal 11 to display a certain page of an electronic book. This information may include an icon and a comment. Further, this information may include information about an allocated region of a content.

When the terminal 11 accesses the electronic book server 12, the electronic book server 12 may transmit information for displaying a screen concerning the electronic book. As necessary, an ID of a user may be promoted to be input after the terminal 11 accesses the electronic book server 12. In such case, because the electronic book server 12 stores information about the user in association with the ID of the user, various services can be provided. For example, information displayed on this terminal 11 may include titles of multiple electronic books. The terminal 11 transmits information for selecting a certain electronic book to the electronic book server 12. Then, the electronic book server 12 transmits data of a cover image and a table of contents of the selected electronic book. The terminal 11 having received the data can cause the display part to display the cover page and the information about the table of contents of the selected electronic book.

When the user decides to purchase an electronic book, the user inputs purchase information to the terminal 11 using the input device of the terminal 11. Then, the terminal 11 transmits the purchase information to the electronic book server 12. The electronic book server 12 receives the purchase information, and stores information indicating that the electronic book has been purchased in association with the ID of the user. Then, when a viewing request of the electronic book is given from the terminal 11 using the ID of the user, information for, e.g., displaying the electronic book is transmitted to the terminal 11.

Then, when the user's terminal 11 selects a certain page, the electronic book server 12 having received the information reads, from the electronic book storage part 21, a page image of the book, the contents included in the electronic book, the allocated regions of the contents, and the comments associated with the contents, and transmits them to the terminal 11. At this occasion, when there is a comment on a content included in the page, the electronic book server 12 selects an icon as necessary, and also transmits information about the icon to the terminal 11 so that the icon is superimposed and displayed on the content.

The terminal 11 having received the information from the electronic book server 12 displays the information about the certain page on the display part. In this manner, the user can view the electronic book.

User Inputs a Comment into an Electronic Book

As described above, the image on the certain page of the book is displayed on the display part of the terminal 11. This image includes one or more contents. A region is allocated to each content, although this is not displayed on the display part. For example, when the display part is a touch panel, and a user touches an image of an interesting content (for example, clothes), the content is indicated. When the content is indicated, a comment input field for, e.g., Twitter (registered trademark) is displayed on the display part. Then, the user uses the input part to write characters into the comment input field. Then, a comment associated with a certain content is input to the terminal 11. When the user decides to transmit the content, a transmission button displayed on the display part is selected. Then, a transmission instruction is input to the terminal 11. Then, the terminal 11 transmits information about the content and the ID of the user as well as the comment to the electronic book server 12. This comment may be transferred to a Twitter (registered trademark) site as a tweet of the Twitter (registered trademark).

In the explanation above, Twitter (registered trademark) is used as an example. However, a publicly known system can be used as necessary in order to input a comment. Other examples of input of comments include Evernote (registered trademark) and Facebook (registered trademark).

Update of Electronic Book Data

The electronic book server 12 receives information about the ID of the user and the certain content (identification information of the content) as well as the comment, which are transmitted from the terminal 11. Then, the electronic book server 12 stores the received comment to the electronic book storage part 21, and updates the electronic book data. At this occasion, the comment and the ID of the user that provided the comment are also stored in association with identification information of the certain content. Preferably, the electronic book storage part 21 also updates the number of times the comment is viewed.

Adjustment of Icon

When the content is displayed on the display part of the terminal 11, and there is a comment about the content, the terminal 11 implementing the system according to the present invention can select a mode in which a certain icon is displayed on the display part. When this mode is selected, a certain page of an electronic book is displayed on the display part, and an icon is overlaid and displayed on an image of a content. The icon may be displayed only when there is a comment associated with the content.

The type or the color of the displayed content may be changed on the basis of the ID of the user. For example, when a person who posted a content to an electronic book is an individual user, a pictographic character may be displayed as an icon. By using a pictographic character as an icon representing an individual in this manner, the access to a pictographic character providing site can be increased. In addition, a particular pictographic character is displayed only to friends who have downloaded the particular pictographic character, and therefore, this can indicate that the comment was posted by a friend.

For example, when the amount of comments stored in association with the certain content is equal to or more than a threshold value, the icons concerning all the comments displayed on the terminal reduces readability of the contents instead of improving the readability thereof. Therefore, the threshold value is stored in the storage part, and the number of comments stored in association with the certain content is compared. When the number of comments stored in association with the certain content is determined to be more than the threshold value, processing is performed to reduce the icons displayed. For example, the user information storage part 43 stores an evaluation rank of a user in association with an ID of the user. The comments posted by users of which evaluations are low are deleted until the number of comments becomes less than the threshold value. The electronic book server has a clock for measuring a current time. The current time and posting times of the comments are compared, and processing is performed so as not to display a predetermined number of old icons. Further, the number of times a comment is viewed is stored, and processing is performed so as not to display an icon for a comment that is viewed a few number of times. By doing so, even when multiple comments are given, the terminal 11 can display only icons concerning comments interesting to the user.

Display of Avatar

The user information storage part 43 includes the ID of a user and the avatar of a user. The user information storage part 43 may store the facial picture or the facial image of a user. In addition, the user information storage part 43 may store at least one or more of the sex, the height, the body shape, the measurements, the weight, and a portrait of a user, and a picture of clothes owned, an image of clothes, an image of clothes already purchased, and an accessory image. The clothes image generating part 55 uses the ID of the user to read user's avatar information from the user information storage part 43. Then, the clothes specified as a content is processed so that it represents the state in which the user wears the clothes. This processing may be done by, for example, partially enlarging or reducing an image according to the body shape. Then, for example, the clothes image generating part 55 generates an image representing the state in which the user wears the specified clothes. Then, the obtained image is transmitted to the terminal 11. Then, for example, the image is superimposed on the content 61, and an avatar wearing the content 61 is displayed.

Hereinafter, another embodiment according to the present invention will be explained. In the explanation below, explanation about the same configuration as that in the above embodiment is omitted, and a configuration different from that in the above embodiment will be mainly explained.

FIG. 11 illustrates an example of an image displayed on the display part 32 of the terminal 11 of another embodiment of the present invention. In the another embodiment of the present invention, the user can also select an icon 64 along with input of a comment 65 in association with a particular content. The example of icon represents a feeling that the user has about a particular content. For example, examples of icons include an icon of “joy”, an icon of “anger”, an icon of “sadness”, and an icon of “fun”. However, various other things can be represented using icons. An icon numerical value is set for each icon selected by a user. Different numerical values according to the types of icons may be set as icon numerical values, or the same numerical value may be set. When a particular icon 64 is selected from multiple icons 64 in association with a content specified with the terminal 11, information about the selected icon is transmitted to the server 12. When the server 12 receives information about the icon from the terminal 11, the server 12 accumulates and adds icon numerical values for each icon in association with a specified content, and obtains a total numerical value of the icon numerical values. The server 12 transmits the calculated total numerical value for each icon to the terminal 11. Then, the total numerical value for each icon associated with the content is displayed on the display part 32 of the terminal 11. For example, in the example as illustrated in FIG. 11, the total numerical values of the icons are displayed on a total numerical value display region 66.

Hereinafter, a configuration of the another embodiment of the present invention will be explained more specifically.

In the another embodiment of the present invention, the electronic book server 12 includes not only the configuration of the above embodiment but also an icon storage part 41 and a total numerical value storage part 56.

The icon storage part 41 stores multiple icons displayed on the terminal 11 as well as icon numerical values respectively set for the icons. As described above, an icon preferably represents user's feeling. An example of icon numerical value includes a numerical value that can be calculated by a computer. For example, one to 10 points are set according to the types of the icons. The icons and the icon numerical values are preferably stored in association with each other.

The total numerical value storage part 56 stores a total numerical value of icon numerical values for each icon stored in the icon storage part 41, in association with a content stored in the electronic book storage part 21. In other words, the total numerical value storage part 56 stores the content, the icon, and the total numerical value of the icon numerical values, which are associated with each other.

As described above, the electronic book server 12 includes the icon storage part 41 and the total numerical value storage part 56. Accordingly, the reading part 23 of the electronic book server 12 reads information about the electronic book stored in the electronic book storage part 21 as well as information about multiple icons stored in the icon storage part 41, on the basis of information received by the receiving part 22 of the electronic book server.

The information updating part 24 of the server 12 updates information stored in the electronic book storage part 21 as well as the total numerical value stored in the total numerical value storage part 56, on the basis of information received by the receiving part 22 of the electronic book server. In other words, the information updating part 24 performs calculation processing for adding icon numerical values stored in the total numerical value storage part 56 on the basis of information received from the terminal. 11 (selection information of icons), and stores the total numerical value, obtained by adding the icon numerical values, to the total numerical value storage part 56.

The transmitting part 25 of the server 12 transmits, to the terminal 11, information about multiple icons as well as information about the electronic book including one or more contents which is read by the reading part 23.

On the other hand, in the another embodiment of the present invention, the terminal 11 includes not only the configuration of the above embodiment but also an icon selecting part 57.

The icon selecting part 57 is means for selecting an icon associated with the content specified by the content specifying part 33, from among multiple icons displayed on the display part 32. When information about multiple contents is received from the electronic book server 12, the display part 32 of the terminal 11 displays not only information about the electronic book but also an indication for prompting a user to select an icon from multiple icons as illustrated in FIG. 11, for example. Then, the icon selecting part 57 performs processing for selecting an icon from multiple icons in association with the content specified by the content specifying part 33.

In other words, the receiving part 31 of the terminal 11 receives information about multiple icons and information about the electronic book transmitted from the electronic book server 12. The display part 32 of the terminal 11 displays the information about the electronic book and multiple icons, on the basis of the information about the electronic book received by the receiving part 31 of the terminal. The content specifying part 33 specifies a particular content included in the electronic book displayed on the display part 32, by selecting an allocated region of a content. The input part 34 of the terminal 11 inputs an instruction and a comment about the content specified by the content specifying part 33. In addition, the icon selecting part 57 selects an icon associated with the content specified by the content specifying part 33 from among multiple icons displayed on the display part 32.

The transmitting part 35 of the terminal 11 transmits, to the electronic book server 12, the instruction and the comment about the content which are input with the input part 34 of the terminal and the icon selected with the icon selecting part 57.

As described above, in the electronic book system according to the another embodiment, information is exchanged between the terminal 11 and the electronic book server 12 via an electric communication network. When the electronic book server 12 receives information about an icon from the terminal, the electronic book server 12 causes the information updating part 24 to update the total numerical value of the icon numerical values stored in the total numerical value storage part 56, in association with the icon received from the terminal 12. The total numerical value of the icon numerical values is updated every time an icon is selected with the terminal 11. Then, the electronic book server 12 transmits, to the terminal 12 via the transmitting part 25 of the server, information for displaying the total numerical value of the icon updated by the information updating part 24. As described above, the terminal 11 receives information for displaying the total numerical value of the icon from the electronic book server 12, and displays the total numerical value of the icon on the display part 32. An example where the display part 32 displays the total numerical value of the icon is illustrated in FIG. 11. As illustrated in FIG. 11, the total numerical value of the icon is preferably displayed on the total numerical value display region 66, in association with a particular content.

Because of such configuration, in the another embodiment of the present invention, the user of the electronic book system can visually understand what kind of feeling that the other users have about a particular content by seeing the total numerical value of the icon numerical values.

The electronic book server 12 according to the another embodiment may further include an image data storage part 58 and an image data transmitting part 59.

The image data storage part 58 stores threshold values of the total numerical values stored in the total numerical value storage part 56 as well as multiple pieces of image data. In other words, the image data storage part 58 stores the threshold value of the total numerical value of the icon numerical values in association with each piece of image data. For example, the image data storage part 58 extracts a particular piece of image data representing feeling “fun” when the total numerical value of the icon numerical values of the icon meaning “fun” in association with a certain content is more than 100 pt.

When the total numerical value updated by the information updating part 24 is more than the threshold value stored in the image data storage part 58, the image data transmitting part 59 transmits, to the terminal 11, information for displaying the piece of image data, which is more than the threshold value, on the display part 32 of the terminal 11. More specifically, in the total numerical value storage part 56 of the electronic book server 12, every time an icon is selected with the terminal 11, the total numerical value of the icon numerical values corresponding to the selected icon in association with the content is accumulated, added, and stored. Then, the electronic book server 12 determines whether the total numerical value thus accumulated and added is more than the threshold value stored in the image data storage part 58. When the electronic book server 12 determines that the total numerical value thus accumulated and added is more than the threshold value stored in the image data storage part 58, the electronic book server 12 causes the image data transmitting part 59 to transmit, to the terminal 11, image data stored in association with the total numerical value that is more than the threshold value. The terminal 11 having received the image data from the electronic book server 12 performs processing to display the image data on the display part 32.

As described above, according to the another embodiment, the image data can be displayed on the display part 32 of the terminal 11, upon a determination that the total numerical value accumulated and added for each icon in association with the content stored in the total numerical value storage part 56 is more than a certain threshold value. Therefore, the user can visually understand, based on the image data, that the icon numerical value of the icon associated with the particular content (for example, a numerical value representing feeling) is more than a certain value.

[Configuration of Computer]

FIG. 6 is a block diagram illustrating an aspect of embodiment (computer) of the present invention. This aspect of embodiment relates to a computer (a computer for graphics and the like) with computer graphics. As illustrated in FIG. 6, this computer 101 includes a central processing part (CPU) 102, a geometry calculation part such as a geometry calculation circuit 103, a drawing part such as a renderer 104, a texture generating part such as a texture generating circuit 105, an illumination processing part such as an illumination processing circuit 107, a display information generating part such as a display circuit 108, a frame butler 109, and a monitor 110. These elements are connected via a bus and the like, and can transmit data to each other. In addition, the computer 101 may include a storage part having a main memory, not shown, a work memory 111 serving as various kinds of tables and a work region, a texture memory 112 storing a texture, and the like. Hardware constituting each part is coupled via a bus, for example. The storage part may be constituted by a RAM such as a VRAM, a CR-ROM, a DVD, a hard disk, and the like.

The central processing part (CPU) 102 is a device for controlling a program for generating an image and the like. The work memory 111 may store data, display lists, and the like used by the CPU 102. Then, the CPU 102 may read a program and he like stored in the main memory, and may perform predetermined processing. However, predetermined processing may he performed by only hardware processing. For example, the CPU 102 reads polygon data serving as three-dimensional object data of world coordinates from the work memory 111, and outputs the polygon data to the geometry calculation circuit 103. More specifically, the CPU 102 may be those having, as necessary, a main processor, a coprocessor, a data processing processor, a four fundamental arithmetic operations calculation circuit, a general-purpose calculation circuit, or the like. These are coupled via a bus and the like, so that signals can be exchanged. In addition, a data uncompressing processor for uncompressing compressed information may also be provided.

The geometry calculation circuit 103 is a circuit for, e.g., converting coordinates of input polygon data into data of a view point coordinate system in which a view point is an origin point. The geometry calculation circuit 103 outputs the processed polygon data to the renderer 104. More specific examples of geometry calculation circuits include a geometry processor, a coprocessor, a data processing processor, a four fundamental arithmetic operations calculation circuit, a general-purpose calculation circuit, or the like, which is coupled with the main processor via a bus and the like.

The renderer 104 is a circuit or a device for converting data in units of polygons into data in units of pixels. The renderer 104 outputs the data in units of pixels to the texture generating circuit 105. Specific examples of renderers 104 include a data processing processor, a four fundamental arithmetic operations calculation circuit, a general-purpose calculation circuit, or the like, which is coupled with the main processor via a bus and the like.

The texture generating circuit 105 is a circuit for generating texture colors in units of pixels on the basis of texture data stored in the texture memory 112. The texture generating circuit 105 outputs data in units of pixels having the texture color information to the illumination processing circuit 107. Specific examples of texture generating circuits 105 include a data processing processor, a four fundamental arithmetic operations calculation circuit, a general-purpose calculation circuit, or the like, which is coupled with the main processor via a bus and the like.

The illumination processing circuit 107 is a circuit for, e.g., adding shades to polygons having the texture color information, in units of pixels, using a normal vector, a barycentric coordinate, and the like. The illumination processing circuit 107 outputs the shaded image data to the display circuit 108. Specific examples of illumination processing circuits 107 include a data processing processor, a four fundamental arithmetic operations calculation circuit, a general-purpose calculation circuit, or the like, which is coupled with the main processor via a bus and the like. Then, shadowing may be done by reading information about lights from a table stored in a memory and the like as necessary.

The display circuit 108 is a circuit for writing image data received from the illumination processing circuit 107 into the frame buffer 109, reading the image data written to the frame buffer 109, and controlling the image data to obtain display image information. The display circuit 108 outputs the display image information to the monitor 110. Specific examples of display circuits include a drawing processor, a data processing processor, a four fundamental arithmetic operations calculation circuit, a general-purpose calculation circuit, or the like, which is coupled with the main processor via a bus and the like.

The monitor 110 is a device for displaying a computer graphics image in accordance with input display image information.

The computer according to the present invention has the image generating device according to the present invention as the renderer, the texture generating circuit, and the display device, and therefore, the size of hardware can be reduced by sharing circuit devices therein. Application of a geometry portion to a 2D vector image enables geometry conversion of the 2D vector image, and therefore, shape modification, enlarging, and reduction can be applied to a vector image with matrix calculation, without performing calculation using dedicated hardware or software. Further, 2D and 3D display instructions, which have been separately treated in the past, can be treated in an integrated manner, and the processing for combining these 2D/3D images can be performed at the same time, and this effectively prevents the system from being in a complicated situation.

[Operation of Computed]

Hereinafter, an example of operation for generating an image using the computer will be explained. The CPU 102 reads polygon data from the work memory 111, and outputs the polygon data to the geometry calculation circuit 103. The geometry calculation circuit 103 converts coordinates of input polygon data into data of a view point coordinate system in which a view point is an origin point. The geometry calculation circuit 103 outputs the processed polygon data to the renderer 104. The renderer 104 converts data in units of polygons into data in units of pixels. The renderer 104 and the texture generating circuit 105 generate texture colors in units of pixels on the basis of texture data stored in the texture memory 112. The texture generating circuit 105 outputs data in units of pixels having the texture color information to the illumination processing circuit 107. The illumination processing circuit 107 adds shades to polygons having the texture color information, in units of pixels, using a normal vector, a barycentric coordinate, and the like. The illumination processing circuit 107 outputs the shaded image data to the display circuit 108. The display circuit 108 writes image data received from the illumination processing circuit 107 into the frame buffer 109, reads the image data written to the frame buffer 109, and obtains display image information. At this occasion, by using information of an edge buffer and the like at the same time, 2D/3D combining processing can be performed. The display circuit 108 outputs the display image information to the monitor 110. The monitor 110 displays a computer graphics image in accordance with the input display image information.

The computer according to the present invention has the image generating device according to the present invention as the renderer, the texture generating circuit, and the display device, and therefore, the size of hardware can be reduced by sharing circuit devices therein. Application of a geometry portion to a 2D vector image enables geometry conversion of the 2D vector image, and therefore, shape modification, enlarging, and reduction can be applied to a vector image with matrix calculation, without performing calculation using dedicated hardware or software. Further, 2D, vector and 3D display instructions, which have been separately treated in the past, can be treated in an integrated manner, and the processing for combining these 2D/3D and vector images can be performed at the same time, and this effectively prevents the system from being in a complicated situation.

[Configuration of Game Machine]

FIG. 7 is a block diagram illustrating an embodiment (game machine) of the present invention. The embodiment illustrated in this block diagram can be preferably used as a game machine for portable, home, or business use in particular. Accordingly, in the explanation below, this embodiment is explained as a game machine. The game machine as illustrated in the figure may have at least a processing part 200 (or a processing part 200 and a storage part 270, or a processing part 200, a storage part 270, and an information storage medium 280), and each of the other blocks (for example, an operation part 260, a display part 290, a sound output part 292, a portable information storage device 294, a communication part 296) may be any constituent element.

The processing part 200 performs various kinds of processing such as control of the entire system, giving instructions to blocks within the system, game processing, image processing, and sound processing. The functions of the processing part 200 can be achieved using hardware such as various kinds of processors (such as a CPU and a DSP) or ASIC (gate array and the like) or a given program (game program).

The operation part 260 is provided with which a player inputs operation data. The functions of the operation part 260 can be achieved using, for example, a controller having a lever, a button, an external frame, and hardware. In particular, in a case of a portable game machine, the operation part 260 may be formed integrally with a main body of a game machine. Processing information given by the controller is transmitted to a main processor and the like via a serial interface (I/F) or a bus.

The storage part 270 serves as a work region for the processing part 200, the communication part 296, and the like. The storage part 270 may store, e.g., programs and various kinds of tables. The storage part 270 may include, for example, a main memory 272, a frame buffer 274, and a texture storage part 276, and in addition, may store various kinds of tables. The functions of the storage part 270 can be achieved using hardware such as a ROM and a RAM. Examples of RAMs include a VRAM, a DRAM, or an SRAM, and they may be selected as necessary in accordance with the purpose. The VRAM and the like constituting the frame buffer 274 are used as a work region of various kinds of processors.

The information storage medium (computer-usable storage medium) 280 stores information such as programs and data. The information storage medium 280 may be sold as a so-called game cassette and the like. Further, the functions of the information storage medium 280 can be achieved using hardware such as an optical disk (CD, DVD), a magneto-optical disk (MO), a magnetic disk, a hard disk, a magnetic tape, or a memory (ROM). The processing part 200 performs various kinds of processing on the basis of the information stored in the information storage medium 280. The information storage medium 280 stores information (program or program and data) for executing means of the present invention (the present embodiment) (in particular, blocks included in the processing part 200). When the storage part stores information such as programs and data, the information storage medium 280 may not be necessary. For example, a portion or all of the information stored in the information storage medium 280 is transferred to the storage part 270 at the time of power-on to the system. Examples of information stored in the information storage medium 280 include those including at least two of a program code for performing predetermined processing, image data, sound data, shape data of a display object, table data, list data, information for giving instructions for processing according to the present invention, and information for performing processing according to the instructions.

The display part 290 outputs an image generated according to the present embodiment. These functions can be achieved using hardware such as a CRT (cathode-ray tube), an LCD (liquid crystal), an OEL (organic electroluminescent devices), a PDP (plasma display panel) or an HMD(head mount display).

The sound output part 292 outputs sound. The functions of the sound output part 292 can be achieved using hardware such as a speaker. The sound output is subjected to, for example, sound processing by a sound processor connected to a main processor and the like via a bus, and is output from a sound output part such as a speaker.

The portable information storage device 294 stores, e.g., individual data of a player and saved data. Examples of portable information storage devices 294 include a memory card and a portable game device. The functions of the portable information storage device 294 can be achieved using publicly known storage means such as a memory card, a flash memory, a hard disk, and a USB memory.

The communication part 296 is any part that performs various kinds of controls for communication with the outside (for example, a host device and another image generating system). The functions of the communication part 296 can be achieved using hardware such as various kinds of processors or communication ASIC and programs.

The programs or data for executing the game machine may be distributed from an information storage medium possessed by a host device (server) via a network and the communication part 296 to the information storage medium 280.

Examples of processing parts 200 include those including a game processing part 220, an image processing part 230, and a sound processing part 250. Specific examples of processing parts 200 include a main processor, a coprocessor, a geometry processor, a drawing processor, a data processing processor, a four fundamental arithmetic operations calculation circuit, a general-purpose calculation circuit, or the like, which are coupled via a bus as necessary, whereby signals can be exchanged with each other. In addition, a data uncompressing processor for uncompressing compressed information may also be provided.

In this case, the game processing part 220 performs various kinds of game processing such as coil (charge) reception processing, setting processing of various kinds of nodes, game proceeding processing, setting processing of a selection screen, processing for obtaining a position and a rotation angle (rotation angle about X, Y, or Z axis) of an object, processing for operating an object (motion processing), processing for obtaining a position of a view point (position of a virtual camera) and vision line angle (rotation angle of the virtual camera), processing for arranging an object such as a map object to an object space, hit check processing, processing for calculating a game result (outcome, record), processing for allowing multiple players to play in a common game space, or game over processing, on the basis of operation data given with the operation part 260, individual data given by the portable information storage device 294, saved data, game programs, and the like.

The image processing part 230 performs various kinds of image processing in accordance with instructions and the like given by the game processing part 220. The sound processing part 250 performs various kinds of sound processing in accordance with instructions and the like given by the game processing part 220.

All of the functions of the game processing part 220, the image processing part 230, and the sound processing part 250 may be achieved using hardware, or all of the functions of the game processing part 220, the image processing part 230, and the sound processing part 250 may be achieved using a program. Alternatively, all of the functions of the game processing part 220, the image processing part 230, and the sound processing part 250 may be achieved using both of the hardware and the program. An example of the image processing part 230 includes a part including a geometry calculation part 232 (three-dimensional coordinate calculation part) and a drawing part 240 (rendering part).

The geometry calculation part 232 performs various kinds of geometry calculations (three-dimensional coordinate calculations) such as coordinate conversion, clipping processing, perspective transformation, or light source calculation. Object data (such as apex coordinates of an object, apex texture coordinate, or brightness data) having been subjected to the geometry processing (having been subjected to the perspective transformation) are stored to, for example, the main memory 272 of the storage part 270 and saved therein.

The drawing part 240 draws an object on the frame buffer 274 on the basis of, e.g., the object data having been subjected to the geometry calculation (having been subjected to the perspective transformation) and the texture stored in the texture storage part 276.

An example of the drawing part 240 includes a part including a texture mapping part 242 and a shading processing part 244. More specifically, the drawing part 240 can be implemented using a drawing processor. The drawing processor is connected via a bus and the like to a texture storage part, various kinds of tables, a frame buffer, a VRAM, and the like, and is further connected to a display.

The texture mapping part 242 reads an environment texture from the texture storage part 276, and maps the read environment texture to an object.

The shading processing part 244 performs shading processing on the object. For example, the geometry processing part 232 performs light source calculation, and on the basis of e.g., information about the light source for the shading processing, illumination model, and normal vectors of each apex of the object, the brightness (RGB) of each apex of the object is obtained. The shading processing part 244 obtains the brightness of each dot of primitive surfaces (polygons, curved surfaces) on the basis of the brightness of each apex, by means of, for example, Thong shading and Gouraud shading.

An example of the geometry calculation part 232 includes a part including a normal vector processing part 234. The normal vector processing part 234 may perform processing for rotating a normal vector of each apex of the object (in a broad sense, a normal vector of a plane of the object) using rotation matrix from a local coordinate system to a world coordinate system.

In the game machine according to the present invention, the image processing part includes the image generating device according to the present invention. This enables sharing circuit devices, and those controlled by the game processing part 220 can be integrated with regard to the image processing. There is only one processing part for the vector, 2D, 3D image processing, and this can avoid complicated control and this can reduce the complexity of the system. When the configuration of the game machine is used as necessary, it is possible to provide a device that also functions as an image display device for a slot machine, a Pachinko machine, and the like.

[Basic Operation of Game Machine]

The system is turned on, a part or all of the information stored in the information storage medium 280 is transferred to, for example, the storage part 270. Further, the program for the game processing is stored to, for example, the main memory 272, and various kinds of data arc stored to the texture storage part 276, tables not shown, and the like.

Operation information provided by the operation part 260 is transmitted to the processing part 200 via, for example, a serial interface and a bus, not shown, and the sound processing and various kinds of image processing are performed. Sound information processed by the sound processing part 250 is transmitted via the bus to the sound output part 292, and is emitted as sound. The saved information stored in the portable information storage device 194 such as a memory card is also transmitted to the processing part 200 via a serial interface and a bus, not shown, and predetermined data are read from the storage part 170.

The image processing part 230 performs various kinds of image processing in accordance with the instructions and the like given by the game processing part 220. More specifically, the geometry calculation part 232 performs various kinds of geometry calculations (three-dimensional coordinate calculations) such as coordinate conversion, clipping processing, perspective transformation, or light source calculation. Then, object data (such as apex coordinates of an object, apex texture coordinate, or brightness data) having been subjected to the geometry processing (having been subjected to the perspective transformation) are stored to, for example, the main memory 272 of the storage part 270 and saved therein. Then, the drawing part 240 draws an object on the frame buffer 274 on the basis of, e.g., the object data having been subjected to the geometry calculation (having been subjected to the perspective transformation) and the texture stored in the texture storage part 276.

The information stored to the frame buffer 274 is transmitted via the bus to the display part 290, and is drawn. In this manner, this functions as a game machine having computer graphics.

In the game machine according to the present invention, the image processing part includes the image generating device according to the present invention. The size of the hardware can be reduced by sharing circuit devices, and the vector, 2D, 3D image processing parts are integrated, so that this can prevent the system from being in a complicated situation, whereby useless hardware and control processing can be reduced. Therefore, the cost of developing and manufacturing process and the power consumption can be reduced, and the game machine according to the present invention can be preferably used for a portable game machine and the like in particular.

[Configuration of Cellular Phone]

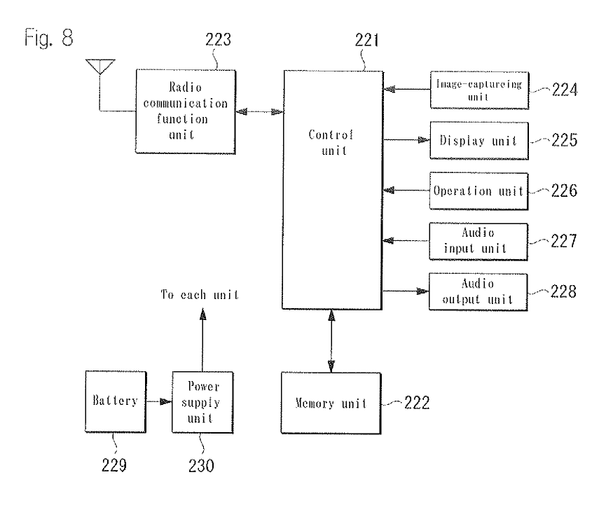

FIG. 8 is a block diagram illustrating an embodiment (cellular phone having computer graphic function) of the present invention. In particular, the embodiment represented in this block diagram can be preferably used as a three-dimensional cellular phone having computer graphic function, a cellular phone having a game function, and a cellular phone having a navigation function.

As illustrated in FIG. 8, this cellular phone includes a control part 221, a memory part 222 storing programs and image data for the control part 221 and serving as a work region for the control part, the communication part, and the like, a radio communication function part 223 for performing the radio communication, an image-capturing part 224 which is any element such as a CCD camera for capturing images of still pictures and motion pictures and converting the images of still pictures and motion pictures into digital signals, a display part 225 such as an LCD for displaying images and characters, an operation part 226 including numeric keys and various kinds of function keys, an audio input part 227 such as a microphone for voice communication, an audio output part 228 for outputting sound of a receiver, a speaker, or the like, a battery 229 for allowing the cellular phone terminal to operate, and a power supply part 230 for stabilizing the battery 229 and distributing power to each of the functional parts.

The control part 201 performs various kinds of processing such as control of the entire cellular phone system, giving instructions to blocks within the system, game processing, image processing, and sound processing. The functions of the control part 221 can be achieved using hardware such as various kinds of processors (such as a CPU and a DSP) or ASIC (gate array and the like) or a given program (game program).

More specifically, the control part includes an image processing part, not shown, and the image processing part includes a geometry calculation part such as a geometry calculation circuit and a drawing part (renderer). Further, the image processing part may include a texture generating circuit, an illumination processing circuit, a display circuit, or the like. Further, the image processing part may include the drawing processing circuit, which is used in the computer and the game machine explained above, as necessary.

In the cellular phone according to the present invention, the image generating device according to the present invention is provided as the drawing part and the geometry calculation part included in the control part. The size of the hardware can be reduced by sharing circuit devices, and the vector, 2D, 3D image processing parts are integrated, so that this can prevent the system from being in a complicated situation, whereby useless hardware and control processing can be reduced. Therefore, the cost of developing and manufacturing process and the power consumption can be reduced, and the cellular phone according to the present invention can be preferably used for a small scale telephone such as a cellular phone.

[Example of Operation of Cellular Phone]

First, communication operation by means of voice will be explained. For example, sound which is input to the audio input part 227 is converted into digital information by an interface, and the control part 221 performs predetermined processing on the sound. Then, it is output from the radio communication function part 223 as a radio signal. When sound information of the other party is received, the radio communication function part 223 receives a radio signal, which is subjected to the predetermined conversion processing, and thereafter, in accordance with the control of the control part 221, it is output from the audio output part 228.

Subsequently, operation and processing for processing an image is basically the same as the operation and the processing which are performed in the computer and the game machine explained above. When processing information is input from the operation part 224 via an interface and a bus, not shown, for example, the geometry processor and the like performs geometry calculation using various kinds of tables and a work region such as a RAM as necessary on the basis of instructions of the image processing part in the control part 221. Further, the renderer of the control part 221 performs rendering processing on the basis of instructions of the image processing part in the control part 221. Image information having been subjected to culling processing, clipping processing, anti-aliasing processing, and. the like as necessary is subjected to predetermined drawing processing performed by the drawing processor, and is stored to the frame buffer. Then, it is displayed as an image on the display part. In this manner, three-dimensional computer graphics are displayed.

In the cellular phone according to the present invention, the image generating device according to the present invention is provided as the drawing part and the geometry calculation part included in the control part. The size of the hardware can be reduced by sharing circuit devices, and the system is prevented from being in a complicated situation. Therefore, the cellular phone according to the present invention can be preferably used for a small scale telephone such as a cellular phone.

### EXAMPLE 1

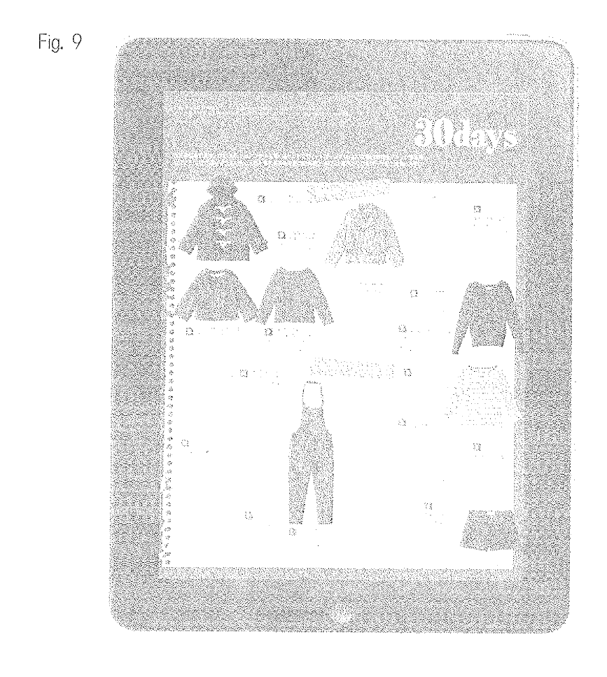

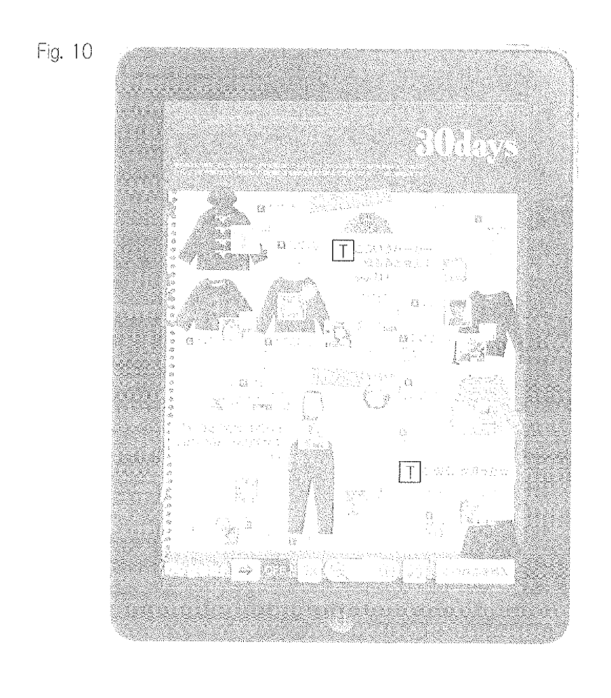

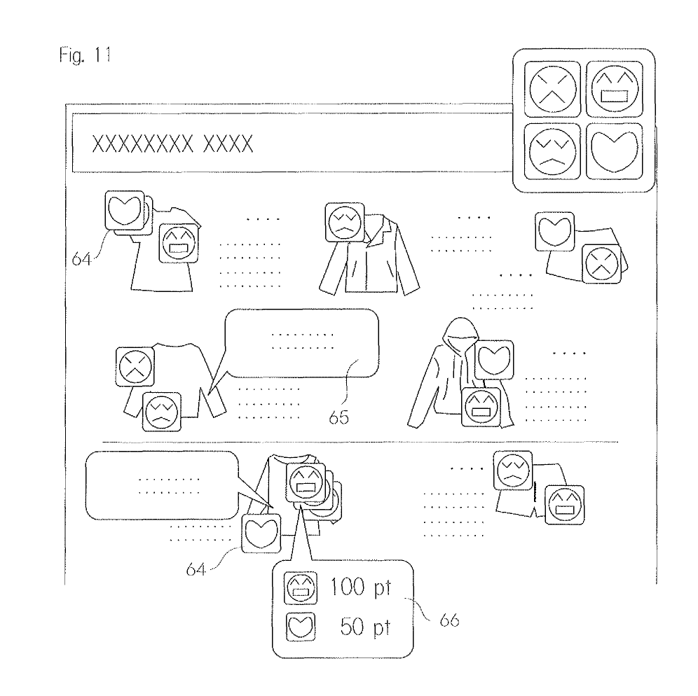

A program for implementing the electronic book system according to the present invention was generated and installed to a server. This program can implement the electronic book system according to the present invention, as long as a terminal has a publicly known browser or viewer. FIG. 9 is a picture showing switching to a drawing illustrating an example in which a terminal displaying an electronic book displays a page image. FIG. 10 is a picture showing switching to a drawing illustrating an example of a page image in which icons and comments are displayed. As illustrated in FIG. 10, according to the present invention, multiple comments are linked to an image of a retrieved book. Therefore, the present invention can make a publication of a page of a retrieved book into a community.

### INDUSTRIAL APPLICABILITY

The present invention relates to an electronic book system, and can be used in an industry of household electrical appliances.

### REFERENCE SIGNS LIST

11 Terminal

12 Electronic book server

13 Electronic book system

21 Electronic book storage part

22 Receiving part of electronic book server

23 Reading part

24 Information updating part

25 Transmitting part of electronic book server

31 Receiving part of terminal

32 Display part

33 Content specifying part

34 Input part

35 Transmitting part of terminal

41 Icon storage part

42 Comment presence/absence determining part

43 User information storage part

44 Icon deciding part

51 Page image retrieving part

52 Content region determining part

53 Camera

55 Clothes image generating part

56 Total numerical value storage part

57 Icon selecting part

58 Image data storage part

59 Image data transmitting part

1. An electronic book system (13) comprising a terminal (11) capable of displaying an electronic book and an electronic book server (12) connected to the terminal (11) via a communication network,
wherein the electronic book server (12) includes:
an electronic book storage part (21) storing a page image of an electronic book, a content included in the electronic book, an allocated region of the content, and a comment associated with the content;
a receiving part (22) of the electronic book server receiving information transmitted from the terminal (11);
a reading part (23) reading information about an electronic book stored in the electronic book storage part (21), on the basis of information received by the receiving part (22) of the electronic book server;
an information updating part (24) updating the information stored in the electronic book storage part (21) on. the basis of information received by the receiving part (22) of the electronic book server; and
a transmitting part (25) of the electronic book server transmitting to the terminal (11), information about the electronic book including one or more contents read by the reading part (23),
the terminal (11) includes:
a receiving part (31) of the terminal receiving information about the electronic book including information about one or more contents transmitted from the electronic book server (12);
a display part (32) displaying the information about the electronic book, on the basis of the information about the electronic book received by the receiving part (31) of the terminal;
a content specifying part (33) specifying a particular content included in the electronic book including the one or more contents displayed on the display part (32), by selecting an allocated region of a content;
an input part (34) of the terminal inputting an instruction and a comment about the content specified by the content specifying part (33); and
a transmitting part (35) of the terminal transmitting, to the electronic book server (12), the instruction and the comment about the content which is input by the input part (34) of the terminal,
wherein the allocated region of a content is a region including an image of the content displayed on the display part (32) of the terminal.

2. The electronic book system according to claim 1,
wherein the electronic book server (12) further includes:
an icon storage part (41) storing an icon displayed on the terminal (11); and
a comment presence/absence determining part (42) determining whether a comment stored in association with a content included in the electronic book storage part (21) is presence or absence,
when the comment presence/absence determining part (42) determines that there is a comment associated with a content displayed on the terminal (11), the transmitting part (25) of the electronic book server transmits, to the terminal (11), information for displaying an icon in association with the comment.

3. The electronic book system according to claim 1,
wherein the electronic book storage part (21) further stores an ID of a user who posted a comment, a posting time of the comment, and the number of times the comment has been browsed, which are stored in association with the comment,
wherein the electronic book server (12) further includes:
an icon storage part (41) storing multiple types of icons displayed on the terminal (11);
a user information storage part (43) storing information about a user including an ID of the user; and
an icon deciding part (44) determining an icon displayed on the terminal, using the ID of the user who posted the comment, the posting time of the comment, and the number of times the comment has been browsed,
the transmitting part (25) of the electronic book server transmits, to the terminal (11), information for displaying the icon determined by the icon deciding part (44), in association with the comment.

4. The electronic book system according to claim 1,
wherein the electronic book server (12) further includes:
a page image retrieving part (51) retrieving a page image of a book; and
a content region determining part (52) obtaining region information of a content included in a page by sweeping a page image of the book retrieved by the page image retrieving part (51).

5. The electronic book system according to claim 1,
wherein the terminal (11) further includes a camera (53) capturing an image,
and the transmitting part (35) of the terminal transmits image data of a certain page of a certain book taken with the camera (53) to the electronic book server (12)
the electronic book server (12) receives the image data of the page transmitted from the terminal (11), reads information about the received page from the electronic book storage part (21), and transmits the information to the terminal (11).

6. The electronic book system according to claim 1,
wherein the content includes an image of clothes,
the electronic book server (12) further includes:
a user information storage part (43) storing information about a user including an avatar of the user and an ID of the user; and
a clothes image generating part (55) generating an image in which an avatar wears clothes, using an avatar of a user and an image of clothes.

7. An electronic book system (13) comprising a terminal (11) capable of displaying an electronic book and an electronic book server (12) connected to the terminal (11) via a communication network,
wherein the electronic book server (12) includes:
an electronic book storage part (21) storing page images of an electronic book, contents included in the electronic book, allocated regions of the content, and comments associated with the content;
an icon storage part (41) storing multiple icons displayed on the terminal (11) as well as icon numerical values respectively set for the icons;
a total numerical value storage part (56) storing a total numerical value of icon numerical values for each icon stored in the icon storage part (41), in association with a content stored in the electronic book storage part (21);
a receiving part (22) of the electronic book server receiving information transmitted from the terminal (11);
a reading part (23) reading information about an electronic book stored in the electronic book storage part (21) and information about an icon stored in the icon storage part (41), on the basis of information received by the receiving part (22) of the electronic book server;
an information updating part (24) updating the information stored in the electronic book storage part (21) and the total numerical value stored in the total numerical value storage part (56), on the basis of information received by the receiving part (22) of the electronic book server; and
a transmitting part (25) of the electronic book server transmitting, to the terminal (11), information about the electronic book including one or more contents read by the reading part (23) as well as information about multiple icons,
the terminal (11) include:
a receiving part (31) of the terminal receiving information about multiple icons and information about the electronic book including one or more contents transmitted from the electronic book server (12);
a display part (32) displaying the information about the electronic book and multiple icons, on the basis of the information about the electronic book received by the receiving part (31) of the terminal;
a content specifying part (33) specifying a particular content included in the electronic book including one or more contents displayed on the display part (32), by selecting an allocated region of a content;
an input part (34) of the terminal inputting an instruction and a comment about the content specified by the content specifying part (33);
an icon selecting part (57) selecting an icon associated with the content specified by the content specifying part (33) from among multiple icons displayed on the display part (32); and
a transmitting part (35) of the terminal transmitting, to the electronic book server (12), the instruction and the comment about the content which are input with the input part 34 of the terminal and the icon selected with the icon selecting part (57),
wherein the allocated region of a content is a region including an image of a content displayed on the display part (32) of the terminal, and
when the electronic book server (12) receives information about an icon from the terminal, the electronic book server (12) causes the information updating part (24) to update the total numerical value of the icon numerical values stored in the total numerical value storage part (56), in association with the icon received from the terminal (12), and transmits, to the terminal (12) via the transmitting part (25) of the server, information for displaying the total numerical value of the icon updated by the information updating part (24).

8. The electronic book system according to claim 7,
wherein the electronic book server (12) further includes:
an image data storage part (58) storing threshold values of the total numerical values stored in the total numerical value storage part (56) as well as multiple pieces of image data; and
an image data transmitting part (59) transmitting, to the terminal 11, information for displaying the piece of image data, which is more than the threshold value, on the display part (32) of the terminal (11) when the total numerical value updated by the information updating part (24) is more than the threshold value stored in the image data storage part (58).
